(19) United States
(12) Patent Application Publication
(10) Pub. No.: US 2010/0063857 A1
(43) Pub. Date: Mar. 11, 2010

(54) System and Method of Providing Feedback Related to Advertisement Data

(75) Inventor: Dale Malik, Dunwoody, GA (US)

Correspondence Address: AT&T Legal Department - LNA;Attn: Patent Docketing, Room 2A- 207, One AT & T Way, Bedminster, NJ, 07921, US

(73) Assignee: AT&T DELAWARE INTELLECTUAL PROPERTY, INC., Wilmington, DE (US)

(21) Appl. No.: 12/208,938

(22) Filed: Sep. 11, 2008

(51) Int. Cl. G06F 17/50; G06Q 30/00

(52) U.S. Cl. 705/7; 705/14.6

(57) ABSTRACT

A method of providing feedback related to advertisement data includes receiving a request from a set-top box device at an advertisement data management system. The request indicates that data related to a particular advertisement is to be sent to a mobile device associated with the set-top box device. The method also includes sending the data related to the particular advertisement, and collateral information including customer location information, to the mobile device. Further, the method includes receiving data from a point of sale venue indicating that a transaction based on the data related to the particular advertisement has been completed. The method also includes storing transaction completion data and the customer location information at a database accessible to an advertisement data source system.

### FIELD OF THE DISCLOSURE

The present disclosure generally relates to communications networks, and more particularly relates to providing feedback related to advertisement data, such as advertisement data delivered to a mobile device.

### BACKGROUND

Television viewing is a common activity. Advertisements are commonly included with television content. A viewer may wish to respond to offers or events associated with advertisements in which the viewer is interested. Additionally, advertisers may desire to provide interested viewers with more information related to offers or events.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram illustrating a particular embodiment of a system to provide feedback related to advertisement data;

FIG. 2 is a block diagram illustrating a second particular embodiment of a system to provide feedback related to advertisement data;

FIG. 3 is a flow diagram illustrating a particular embodiment of a method of providing feedback related to advertisement data;

FIG. 4 is a flow diagram illustrating a second particular embodiment of a method of providing feedback related to advertisement data; and

FIG. 5 is a block diagram of an illustrative embodiment of a general computer system.

The use of the same reference symbols in different drawings indicates similar or identical items.

### DETAILED DESCRIPTION OF THE DRAWINGS

The numerous innovative teachings of the present application will be described with particular reference to the presently preferred exemplary embodiments. However, it should be understood that this class of embodiments provides only a few examples of the many advantageous uses of the innovative teachings herein. In general, statements made in the specification of the present application do not necessarily limit any of the various claimed systems, methods or computer-readable media. Moreover, some statements may apply to some features but not to others.

A method of providing feedback related to advertisement data includes receiving a request from a set-top box device at an advertisement data management system (ADMS). The request indicates that data related to a particular advertisement is to be sent to a mobile device associated with the set-top box device. The method also includes sending the data related to the particular advertisement, and collateral information including customer location information, to the mobile device. Further, the method includes receiving data from a point of sale venue indicating that a transaction based on the data related to the particular advertisement has been completed. The method also includes storing transaction completion data and the customer location information at a database accessible to an advertisement data source system.

A system to provide feedback related to advertisement data includes an advertisement data management system (ADMS) including processing logic and memory accessible to the processing logic. The memory includes instructions executable by the processing logic to receive a request from a set-top box device. The request indicates that data related to a particular advertisement is to be sent to a mobile device associated with the set-top box device. The memory also includes instructions executable by the processing logic to retrieve the data related to the advertisement from an advertisement data database. Further, the memory includes instructions executable by the processing logic to send the data related to the particular advertisement, and collateral information including customer location information, to the mobile device. Additionally, the memory includes instructions executable by the processing logic to receive data from a point of sale venue indicating that a transaction based on the data related to the particular advertisement has been completed. Moreover, the memory also includes instructions executable by the processing logic to store transaction completion data and the customer location information at a feedback database accessible to an advertisement data source system.

A computer-readable medium includes processor-readable instructions that are executable by a processor to perform a method. The method includes receiving a request from a set-top box device at an advertisement data management system (ADMS), the request indicating that data related to a particular advertisement is to be sent to a mobile device associated with the set-top box device; sending the data related to the particular advertisement, and collateral information including customer location information, to the mobile device; receiving data indicating that a transaction based on the data related to the particular advertisement has been completed; and storing transaction completion data and the customer location information at a database accessible to an advertisement data source system.

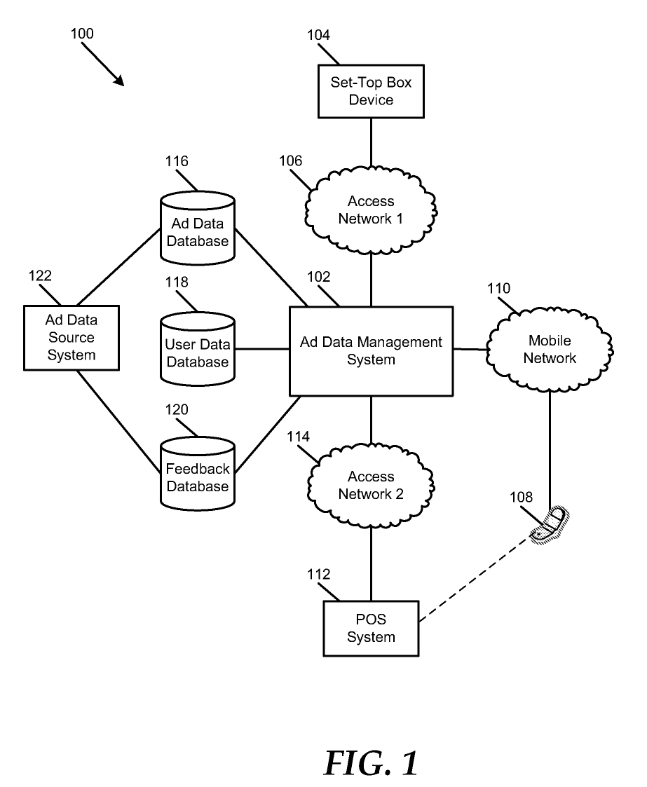

FIG. 1 illustrates a particular embodiment of a system 100 to provide feedback related to advertisement data. The system 100 includes an advertisement data management system (ADMS) 102 of a video service provider, which is adapted to communicate with a set-top box device 104 via a first access network 106. For example, the set-top box device 104 can communicate with an advertisement data management system of an Internet Protocol Television (IPTV) service provider via an IPTV access network. The ADMS 102 is also adapted to communicate with a mobile device 108 via a mobile network 110. In addition, the ADMS 102 is adapted to communicate with a point of sale (POS) system 112 via a second access network 114.

Further, the ADMS 102 is adapted to communicate with an advertisement data database 116. The advertisement data database 116 is adapted to store data related to one or more advertisements. The advertisement-related data can be received at the advertisement data database 116 from an advertisement data source system 122, such as a system associated with an advertiser, an advertisement video content provider, or another source. The ADMS 102 is also adapted to communicate with a user data database 118. The user data database 118 is adapted to store registration information related to mobile devices that are associated with one or more user set-top box devices, such as the set-top box device 104.

For example, the user data database 118 can store contact information related to one or more mobile devices associated with the set-top box device 104, such as the mobile device 108. Further, the ADMS 102 is adapted to communicate with a feedback database 120 that stores fulfillment information indicating that advertisement data sent to one or more mobile devices has been used at a point of sale to complete a transaction. For instance, the feedback database 120 can store data indicating that an electronic coupon related to an advertisement has been redeemed via the mobile phone 108 at a point of sale. The advertisement data database 116, the user data database 118, and the feedback database 120 can comprise a single database or multiple databases.

In an illustrative embodiment, the set-top box device 104 is adapted to receive a request to register the mobile device 108. The set-top box device 104 is adapted to receive registration information, such as contact information, an identifier of the mobile device 108, other registration information associated with the mobile device 108, or a combination thereof, and to send the registration information to the ADMS 102. The ADMS 102 is adapted to receive the registration information from the set-top box device 104 and to store the registration information in association with an identifier of the set-top box device 104 at the user data database 118.

The set-top box device 104 is adapted to receive video content related to a particular advertisement from a video head-end of a video service provider and to send the video content to a display device (not shown) during a program. In one embodiment, the set-top box device 104 can be adapted to receive metadata with the video content, which can include an advertisement identifier, other data related to the particular advertisement, or a combination thereof. The set-top box device 104 can be adapted to receive an advertisement selection command indicating that data related to the particular advertisement is to be sent to the mobile device 108 associated with the set-top box device 104.

In one embodiment, the set-top box device 104 can be adapted to store a plurality of program identifiers, a plurality of advertisement identifiers, or a combination thereof. For example, the set-top box device 104 can be adapted to store a current program identifier and advertisement identifiers for three previous advertisements received at the set-top box device 104. The set-top box device 104 can be adapted to prompt a user to select one of the three previous advertisements in response to an advertisement selection command, and the set-top box device 104 can be adapted to receive a selection of the particular advertisement.

The set-top box device 104 is adapted to send a request to the ADMS 102 indicating that data related to the particular advertisement is to be sent to the mobile device 108. The set-top box device 104 can be adapted to send, with the request, a program identifier indicating a program during which the particular advertisement was displayed, an advertisement identifier received with metadata corresponding to the particular advertisement, or a combination thereof. In other embodiments, the set-top box device 104 can be adapted to send data to the ADMS 102 indicating a time when the set-top box device 104 received the advertisement selection command; a channel to which the set-top box device 104 was tuned when it received the advertisement selection command; other information; or any combination thereof.

The ADMS 102 is adapted to receive from the set-top box device 104 a request indicating that data related to the particular advertisement is to be sent to a mobile device associated with the set-top box device 104, such as the mobile device 108. In a particular embodiment, the ADMS 102 can be adapted to determine whether multiple mobile devices are associated with the set-top box device 104 at the user data database 118. Where more than one mobile device is associated with the set-top box device 104, the ADMS 102 can be adapted to send data indicating the plurality of mobile devices, such as a graphical menu of the plurality of mobile devices, to the set-top box device 104 and to receive data indicating a selection of the mobile device 108 from the set-top box device 104.

Further, the ADMS 102 can be adapted to retrieve data related to the particular advertisement from the advertisement data database 116. The ADMS 102 sends the retrieved advertisement data to the mobile device 108 via a mobile phone number or other mobile address obtained from the user data database 118. Data related to an advertisement can include, for example, electronically readable codes, such as a bar code; an electronic asset that is usable to redeem an offer related to an advertisement, such as an electronic coupon; a mobile version of the advertisement; other data related to an advertisement; or any combination thereof. Other examples of data related to an advertisement include a date, a time, a location, terms, an identification of a product, an identification of a service, other information, or any combination thereof, related to an offer or event.

In addition, the ADMS 102 can be adapted to send collateral information including an advertisement identifier, a program identifier, customer location information (such as a zip code or zip+4), other information, or any combination thereof, to the mobile device 108 with the data related to the particular advertisement. The collateral information can be received at the ADMS 102 from the set-top box device 104, retrieved by the ADMS 102 from one or more of the databases 116-120, or any combination thereof.

The mobile device 108 can be adapted to receive data related to an advertisement and collateral information, and to open or otherwise activate an advertisement wallet feature, such as an advertisement wallet folder, in response to receiving the data. The ADMS 102 can be adapted to send, and the mobile device 108 can be adapted to receive, the data and collateral information from the ADMS 102 via short messaging service (SMS), e-mail, Internet, voice call, another mobile communication method, or any combination thereof. In one embodiment, the data related to the advertisement can include tags or other data indicating that the data is advertisement-related. In another embodiment, the mobile device 108 can be adapted to identify the data as being related to an advertisement based, for example, on the collateral information. The mobile device 108 is adapted to store the data and the collateral information related to the advertisement via the advertisement wallet.

In another illustrative embodiment, the mobile device 108 can be adapted to activate an ad data mode in response to user input. Further, the mobile device 108 can be adapted to detect a particular motion with respect to the display device, the set-top box device 104, other visible object or landmark, or a combination thereof, when the mobile device 108 is in the ad data mode. For instance, the mobile device 108 can determine, via a camera, navigation system or accelerometer, that the mobile device 108 has been moved in a particular direction or a particular combination of directions with respect to the visible object or landmark.

In response to detecting the particular motion, the mobile device 108 can be adapted to send a request to the ADMS 102 for data related to the particular advertisement. The ADMS 102 can be adapted to receive the request and to identify the set-top box device 104 associated with the mobile device 108. The ADMS 102 is adapted to identify programming (such as a channel, a television program, other programming identification, or any combination thereof) received at the set-top box device 104 and to identify, based at least partially on the identified programming, the particular advertisement received at the set-top box device 104 at or about the time that the ADMS 102 received the request for advertisement data from the mobile device 108. The ADMS 102 can be adapted to retrieve advertisement data related to the particular advertisement from the advertisement data database 116 and to send the advertisement data and collateral information to the mobile device 108, where it is stored via the advertisement wallet feature.

The mobile device 108 can be adapted to receive a selection of the advertisement wallet feature, such as via a graphical user interface or hot key at the mobile device 108, and to graphically display selectable indicators of contents of the advertisement wallet. The mobile device 108 can be adapted to receive a selection of an indicator of the advertisement via the graphical display and to display the data related to the selected advertisement. In one embodiment, the POS system 112 is adapted to read at least a portion of the data related to the particular advertisement, and collateral information associated with the data, from the mobile device 108. The POS system 112 is adapted to send the collateral information to the ADMS 102 with an indication that the data related to the particular advertisement has been used in a transaction at a point of sale venue.

For instance, the data related to the particular advertisement can comprise an electronic coupon that is redeemable at the point of sale venue. The POS system 112 can be adapted to read the electronic coupon and the collateral information associated with the electronic coupon via visual transfer, a bar code reader, wireless link (such as Wi-Fi), a physical data link, other methods or any combination thereof. The POS system 112 can be adapted to send to the ADMS 102 the collateral information and data indicating that the electronic coupon has been redeemed at the point of sale venue.

In another example, the mobile device 108 can be adapted to send to the ADMS 102 the electronic coupon or other data related to the particular advertisement and the collateral information. The ADMS 102 can be adapted to send a confirmation code to the mobile device 108, and the confirmation code can be manually entered at the POS system 112. The POS system 112 can be adapted to send the confirmation code, or other data, to the ADMS 102 indicating that a transaction based on the electronic coupon or other data related to the particular advertisement has been completed at the point of sale venue.

The ADMS 102 is adapted to store transaction completion data at the feedback database 120, the transaction completion data indicating that a particular transaction has been completed at the point of sale venue based on an electronic coupon or other data related to the particular advertisement. In addition, the ADMS 102 is adapted to store at least a portion of the collateral information associated with the data related to the particular advertisement at the feedback database 120 in association with the transaction completion data. The transaction completion data and any collateral information are accessible to the advertisement data source system 122 or another system associated with an advertiser or advertising content provider. The advertisement data source system 122 can obtain transaction completion data and collateral information from the feedback database directly or by requesting from the ADMS 102 the transaction completion data and collateral information related to the particular transaction, or to a group of transactions that includes the particular transaction.

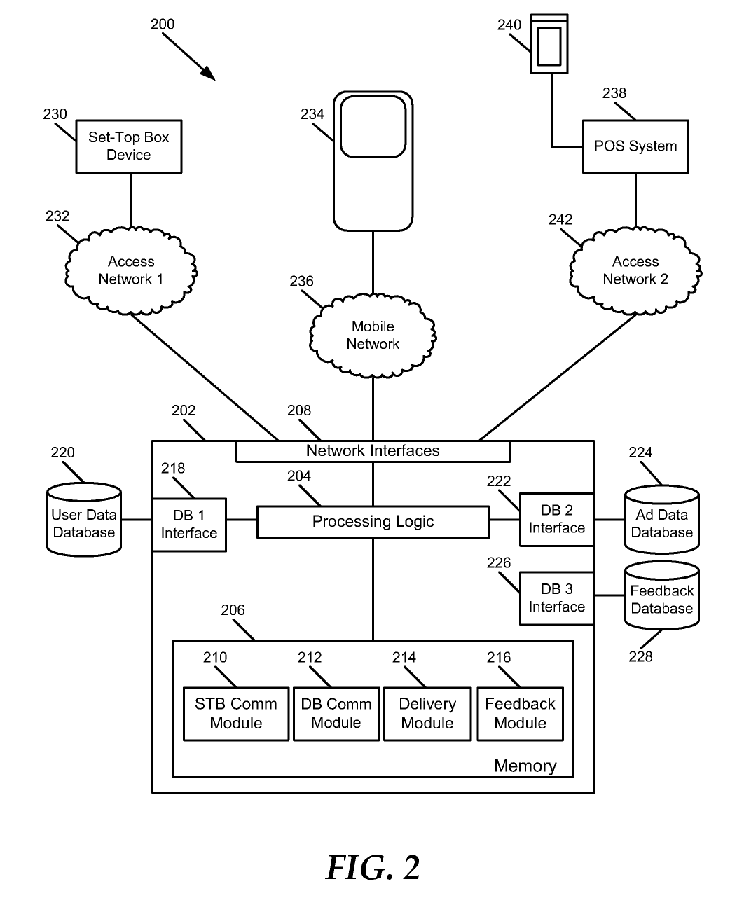

FIG. 2 illustrates a second particular embodiment of a system 200 to provide feedback related to advertisement data. The system 200 includes an ADMS 202 of a video service provider, which is adapted to communicate with a set-top box device 230 via a first access network 232. The ADMS 202 is also adapted to communicate with a mobile device 234 via a mobile network 236. In addition, the ADMS 202 is adapted to communicate with a POS system 238 via a second access network 242.

The ADMS 202 includes processing logic 204 and memory 206 accessible to the processing logic 204. The ADMS 202 can also include a plurality of network interfaces 208 that are adapted to facilitate communication between the ADMS 202, and the first access network 232, the mobile network 236 and the second access network 242. Further, the ADMS 202 includes a first database interface 218 adapted to facilitate communication with a user data database 220; a second database interface 222 adapted to facilitate communication with an advertisement data database 224; and a third database interface 226 adapted to facilitate communication with a feedback database 228.

The memory 206 includes a plurality of modules 210-216. The modules 210-216 can include computer instructions that are readable and executable by the processing logic 204 to implement various functions of the ADMS 202 with respect to providing feedback related to advertisement data. For example, the modules 210-216 can represent various aspects of one or more software applications, operating systems, or other computer programs. In other embodiments, the modules 210-216 can be implemented as hardware logic or a combination of hardware logic and computer instructions.

For example, the memory 206 can include an STB (set-top box) communication module 210 that is executable by the processing logic 204 to receive registration information from the set-top box device 230. The STB module 210 is also executable by the processing logic 204 to receive from the set-top box device 230 a request indicating that data related to a particular advertisement is to be sent to a mobile device associated with the set-top box device 230, such as the mobile device 234. Additionally, in a particular embodiment, the STB module 210 is executable by the processing logic 204 to receive collateral information with the request, such as a program identifier, an advertisement identifier, a customer location identifier, or any combination thereof.

Further, the memory 206 includes a DB (database) communication module 212 that is executable by the processing logic 204 to store registration information related to the mobile device 234, in association with an identifier of the set-top box device 230, at the user data database 220. Further, the DB communication module 212 is executable by the processing logic 204 to retrieve data related to the particular advertisement from the advertisement data database 224. In addition, the DB communication module 212 can be executable by the processing logic 204 to retrieve collateral information from one or more of the databases 220, 224, 228.

The memory 206 includes a delivery module 214 that is executable by the processing logic 204 to send the retrieved advertisement data, and collateral information, to the mobile device 234. The delivery module 214 can be executable by the processing logic 204 to retrieve a mobile phone number or other mobile address from the user data database 220 and to send the advertisement data and collateral information via the mobile phone number or other mobile address.

Additionally, the memory 206 includes a feedback module 216 that is executable by the processing logic 204 to receive collateral information with transaction completion data indicating that the data related to the particular advertisement has been used in a transaction at a point of sale venue. For instance, the data related to the particular advertisement can comprise an electronic coupon that is redeemable at the point of sale venue. The POS system 238 can be adapted to read the electronic coupon and the collateral information associated with the electronic coupon via an optical reader 240 or other device. The POS system 238 can be adapted to send the collateral information and data indicating that the electronic coupon has been redeemed at the point of sale venue to the ADMS 202.

In another embodiment, the feedback module 216 can be executable by the processing logic 204 to send a confirmation code to the mobile device 234, and to receive the confirmation code, other data, or a combination thereof, indicating that a transaction based on the data related to the particular advertisement has been completed at the point of sale venue. For example, the mobile device 234 can be adapted to send an electronic coupon or other data related to the particular advertisement and the collateral information to the ADMS 202, and the feedback module 216 can be executable by the processing logic 204 to send a confirmation code to the mobile device 234 in response. The POS system 238 can be adapted to send the confirmation code, or other data, to the ADMS 202 indicating that a transaction based on the electronic coupon or other data related to the particular advertisement has been completed at the point of sale venue.

The feedback module 216 is executable by the processing logic 204 to store transaction completion data at the feedback database 228 indicating that a particular transaction has been completed at the point of sale venue based on an electronic coupon or other data related to the particular advertisement. In addition, the feedback module 216 can be executable by the processing logic 204 to store collateral information associated with the data related to the particular advertisement at the feedback database 228 in association with the transaction completion data. In one embodiment, the feedback module 216 can be executable by the processing logic 204 to retrieve transaction completion data and collateral information from the feedback database 228 related to the particular transaction and to send the transaction completion data and collateral information to a system associated with an advertiser or advertising content provider.

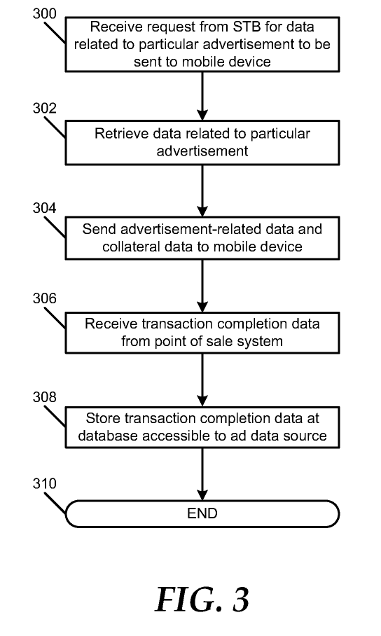

FIG. 3 illustrates a particular embodiment of a method of providing feedback related to advertisement data. At block 300, an advertisement data management system (ADMS) receives a request from a set-top box device for data related to a particular advertisement to be sent to a mobile device associated with the set-top box device. In a particular embodiment, the ADMS also receives an advertisement identifier with the request. Moving to block 302, the ADMS retrieves data related to the particular advertisement from memory or from an advertisement data database.

Continuing to block 304, the ADMS sends the data related to the particular advertisement, as well as collateral data that may include the advertisement identifier, to the mobile device associated with the set-top box device. Advancing to block 306, in a particular embodiment, the ADMS receives transaction completion data from a point of sale system. The transaction completion data indicates that a transaction has been completed at a point of sale venue based on the data related to the particular advertisement. The ADMS can also receive at least a portion of the collateral data. At block 308, the ADMS stores the transaction completion data and any collateral data at a database that is accessible to an advertisement data source, such as a system associated with an advertiser or other source. The method terminates at 310.

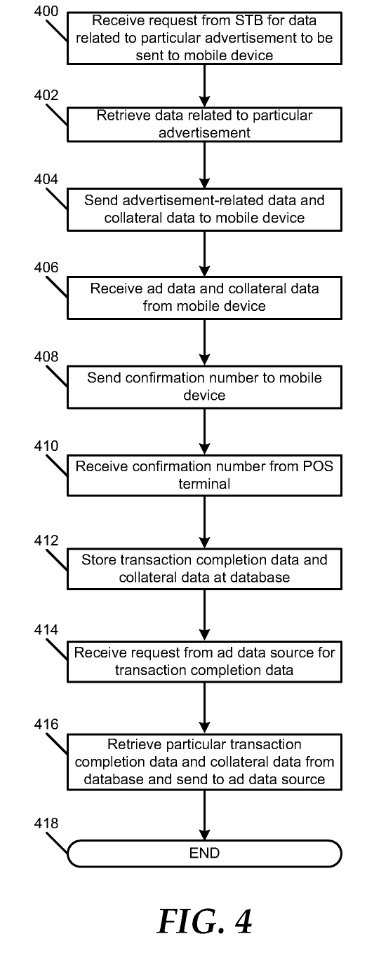

FIG. 4 illustrates a second particular embodiment of a method of providing feedback related to advertisement data. At block 400, an advertisement data management system (ADMS) receives a request from a set-top box device for data related to a particular advertisement to be sent to a mobile device associated with the set-top box device. In a particular embodiment, the ADMS also receives an advertisement identifier with the request. Moving to block 402, the ADMS retrieves data related to the particular advertisement from memory or from an advertisement data database.

Continuing to block 404, the ADMS sends the data related to the particular advertisement, as well as collateral data that may include the advertisement identifier, to the mobile device associated with the set-top box device. Advancing to block 406, in a particular embodiment, the ADMS receives the data related to the particular advertisement and collateral data from the mobile device. At block 408, the ADMS sends a confirmation code to the mobile device. Moving to block 410, the ADMS can receive the confirmation code from a point of sale terminal, indicating that a particular transaction based on the data related to the particular advertisement has been finalized.

Proceeding to block 412, the ADMS stores transaction completion data indicating the particular transaction, and any collateral data received from the mobile device, at a database that is accessible to an advertisement data source, such as a system associated with an advertiser or other source. Continuing to block 414, in an illustrative embodiment, the ADMS receives a request from an ad data source for transaction completion data and collateral data related to the particular transaction or a plurality of transactions that includes the particular transaction. Advancing to block 416, the ADMS retrieves the transaction completion data and collateral data related to the particular transaction and sends the transaction completion data and collateral data to the ad data source. The method terminates at 418.

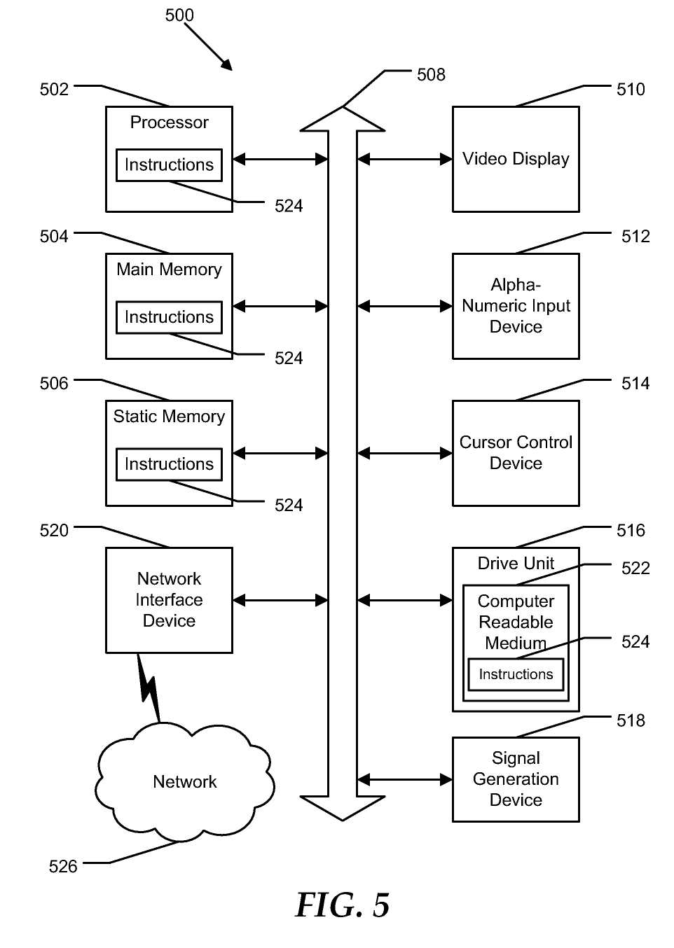

FIG. 5 shows an illustrative embodiment of a general computer 500 including a set of instructions that can be executed to cause the computer system to perform any one or more of the methods or computer based functions disclosed herein. The computer system 500 may operate as a standalone device or may be connected, such as using a network, to other computer systems or peripheral devices. In an illustrative embodiment, such standalone and peripheral devices can include, for example, set-top box devices, mobile devices, servers, databases, other network elements, or any combination thereof, as illustrated in FIGS. 1-2.

In a networked deployment, the computer system may operate in the capacity of a server or as a client user computer in a server-client user network environment, or as a peer computer system in a peer-to-peer (or distributed) network environment. The computer system 500 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 500 can be implemented using electronic devices that provide voice, video or data communication. Further, while a single computer system 500 is illustrated, the term “system” shall also be taken to include any collection of systems or sub-systems that individually or jointly execute a set, or multiple sets, of instructions to perform one or more computer functions.

The computer system 500 may include a processor 502, such as a central processing unit (CPU), a graphics processing unit (GPU), or both. Moreover, the computer system 500 can include a main memory 504 and a static memory 506 that can communicate with each other via a bus 508. As shown, the computer system 500 may further include a video display unit 510, such as a liquid crystal display (LCD), an organic light emitting diode (OLED), a flat panel display, a solid state display, or a cathode ray tube (CRT). Additionally, the computer system 500 may include an input device 512, such as a keyboard, and a cursor control device 514, such as a mouse. The computer system 500 can also include a disk drive unit 516, a signal generation device 518, such as a speaker or remote control, and a network interface device 520.

In a particular embodiment as depicted in FIG. 5, the disk drive unit 516 may include a computer-readable medium 522 in which one or more sets of instructions 524, e.g. software, can be embedded. Further, the instructions 524 may embody one or more of the methods or logic as described herein. In a particular embodiment, the instructions 524 may reside completely, or at least partially, within the main memory 504, the static memory 506, and/or within the processor 502 during execution by the computer system 500. The main memory 504 and the processor 502 also may include computer-readable media. The network interface device 520 can provide connectivity to a network 526, such as a wide area network (WAN), a local area network (LAN), or other network.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 524 or receives and executes instructions 524 responsive to a propagated signal, so that a device connected to a network 526 can communicate voice, video or data over the network 526. Further, the instructions 524 may be transmitted or received over the network 526 via the network interface device 520.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (such as TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure.

Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the FIGs. are to be regarded as illustrative rather than restrictive.

The Abstract of the Disclosure is provided to comply with 37 C.F.R. §1.72(b) and is submitted with the understanding that it will not be used to interpret or limit the scope or meaning of the claims. In addition, in the foregoing Detailed Description of the Drawings, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description of the Drawings, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosed subject matter. Thus, to the maximum extent allowed by law, the scope of the present disclosed subject matter is to be determined by the broadest permissible interpretation of the following claims and their equivalents, and shall not be restricted or limited by the foregoing detailed description.

What is claimed is:

1. A method of providing feedback related to advertisement data, the method comprising:
receiving a request from a set-top box device at an advertisement data management system, the request indicating that data related to a particular advertisement is to be sent to a mobile device associated with the set-top box device;
sending the data related to the particular advertisement, and collateral information including customer location information, to the mobile device;
receiving data from a point of sale venue indicating that a transaction based on the data related to the particular advertisement has been completed; and
storing transaction completion data and the customer location information at a database accessible to an advertisement data source system.

2. The method of claim 1, wherein the request includes an advertisement identifier corresponding to the particular advertisement.

3. The method of claim 2, wherein the advertisement identifier is included in the collateral information.

4. The method of claim 3, wherein the collateral information includes a program identifier.

5. The method of claim 1, further comprising receiving the transaction completion data and at least a portion of the collateral information from the point of sale venue.

6. The method of claim 1, further comprising receiving a request from the advertisement data source for transaction completion data related to the particular transaction and sending the transaction completion data and at least a portion of the collateral information to the advertisement data source.

7. The method of claim 1, further comprising:
receiving a request from the advertisement data source for transaction completion data related to a plurality of transactions that includes the particular transaction; and
sending the transaction completion data and at least a portion of the collateral information to the advertisement data source.

8. A system to provide feedback related to advertisement data, the system comprising:
an advertisement data management system (ADMS) including processing logic and memory accessible to the processing logic, wherein the memory includes instructions executable by the processing logic to:
receive a request from a set-top box device, the request indicating that data related to a particular advertisement is to be sent to a mobile device associated with the set-top box device;
retrieve the data related to the advertisement from an advertisement data database;
send the data related to the particular advertisement, and collateral information including customer location information, to the mobile device;
receive data from a point of sale venue indicating that a transaction based on the data related to the particular advertisement has been completed; and
store transaction completion data and the customer location information at a feedback database accessible to an advertisement data source system.

9. The system of claim 8, wherein the customer location information includes a zip code or a zip+4 code.

10. The system of claim 8, wherein the memory includes instructions executable by the processing logic to retrieve the customer location information from a user data database.

11. The system of claim 10, wherein the ADMS includes at least one interface adapted to facilitate communication between the ADMS and the user data database, the advertisement data database, and the feedback database.

12. The system of claim 11, wherein the user data database, the advertisement data database, and the feedback database comprise at least one database.

13. The system of claim 8, wherein the mobile device is a cellular phone.

14. The system of claim 8, wherein the data related to the particular advertisement includes an electronic coupon.

15. The system of claim 8, further comprising a network interface adapted to communicate with a point of sale system and wherein the memory includes instructions executable by the processing logic to receive the transaction completion data and at least a portion of the collateral information from the point of sale system.

16. The system of claim 8, wherein the ADMS is adapted to send the data related to the particular advertisement and the collateral information to the mobile device via short messaging service (SMS), e-mail, Internet, voice call, or any combination thereof.

17. A computer-readable medium having processor-readable instructions that are executable by a processor to perform a method, the method comprising:
receiving a request from a set-top box device at an advertisement data management system, the request indicating that data related to a particular advertisement is to be sent to a mobile device associated with the set-top box device;
sending the data related to the particular advertisement, and collateral information including customer location information, to the mobile device;
receiving data indicating that a transaction based on the data related to the particular advertisement has been completed; and
storing transaction completion data and the customer location information at a database accessible to an advertisement data source system.

18. The computer-readable medium of claim 17, wherein the data indicating that a transaction based on the data related to the particular advertisement has been completed is received from the mobile device and wherein the method further comprises sending a confirmation code to the mobile device.

19. The computer-readable medium of claim 17, wherein the method further comprises receiving the confirmation code from a point of sale terminal before storing the transaction completion data.

20. The computer-readable medium of claim 17, wherein the data related to the particular advertisement includes a bar code.

21. A method of providing feedback related to advertisement data, the method comprising:
receiving a request from a mobile device at an advertisement data management system, the request indicating that data related to a particular advertisement is to be sent to the mobile device;
sending the data related to the particular advertisement, and collateral information including customer location information, to the mobile device;
receiving data indicating that a transaction based on the data related to the particular advertisement has been completed; and
storing transaction completion data and the customer location information at a database accessible to an advertisement data source system

22. The method of claim 21, further comprising identifying a set-top box device associated with the mobile device.

23. The method of claim 22, further comprising identifying programming received at the set-top box device.

24. The method of claim 23, further comprising identifying the particular advertisement, based at least partially on the identified programming.

25. The method of claim 24, retrieving the advertisement data related to the particular advertisement from an advertisement data database and sending the advertisement data and collateral information to the mobile device.
